(19) United States
(12) Patent Application Publication
(10) Pub. No.: US 2026/0162421 A1
(43) Pub. Date: Jun. 11, 2026

(54) DEEP LEARNING AUTOMATIC TREE SPECIES CLASSIFICATION METHOD BASED ON REMOTE SENSING IMAGES

(71) Applicants: Northeast Forestry University, Harbin (CN); Harbin Normal University, Harbin (CN)

(72) Inventors: Zhen ZHEN, Harbin (CN); Shengheng LIU, Harbin (CN); Qingbin WEI, Harbin (CN); Yinghui ZHAO, Harbin (CN)

(21) Appl. No.: 19/456,185

(22) Filed: Jan. 22, 2026

(30) Foreign Application Priority Data
Feb. 27, 2025 (CN) 202510221664.9

(51) Int. Cl. G06V 10/82; G06N 3/0464; G06N 3/0985; G06V 10/70; G06V 10/776

(52) U.S. Cl. CPC G06V 10/82; G06N 3/0464; G06N 3/0985; G06V 10/776; G06V 10/87

(57) ABSTRACT

A deep learning automatic classification tree species method based on remote sensing images addresses the limitations of existing tree species classification approaches, which tend to focus excessively on single-label classification tasks while overlooking hierarchical multi-label classification, and fail to achieve high-precision species identification through hierarchical labels. The proposed invention is implemented by constructing hierarchical tree species classification data sets at various scales, developing hierarchical tree species classification models, and evaluating the transferability of these models. This method enhances the accuracy of tree species classification, through the dynamic adjustment mechanism of the switcher within the Switcher-HNet and the collaborative functioning of the classifiers, and it reduces misclassification between needleleaf and broadleaf trees, thereby decreasing the overall classification error. The method demonstrates the strong generalization capability of the hierarchical tree species classification model by applying it to tree species data sets of different scales.

### TECHNICAL FIELD

The invention relates to the field of remote sensing image processing technology, and specifically relates to a deep learning automatic tree species classification method based on remote sensing images.

### BACKGROUND

Deep learning technology is widely applied in the field of forestry remote sensing and can be effectively utilized for the automatic classification of tree species. Compared to traditional machine learning methods, deep learning achieves higher accuracy in this task. By feeding remote sensing images containing tree species information into a deep learning model, the model is trained to learn relevant image features, thereby enabling automatic tree species classification. Commonly used deep learning models include Convolutional Neural Networks (CNNs), which are capable of efficiently processing large volumes of remote sensing image data and identifying subtle differences among tree species.

Currently, research on tree species classification mainly focuses on single-label multi-species classification, where each image sample is assigned only one tree species category. In practical classification scenarios, however, a single tree species may have multiple labels, and interactions often exist among these labels. Some studies have found that by leveraging the hierarchical relationships among labels, such as aggregating lower-level tree species labels onto higher-level ones, higher accuracy can be achieved for the higher-level tree species classification. Nevertheless, this improvement in higher-level classification accuracy does not necessarily lead to enhanced accuracy at the more detailed, lower-level tree species categories.

The objective of this invention is to introduce a hierarchical tree species classification model and investigate the hierarchical relationships among tree species. By constructing a hierarchical tree species data set and designing a model structure that incorporates tree species information from different levels within the data set, the accuracy of fine-grained tree species classification can be significantly improved, while the complexities of multi-species classification can be reduced.

### SUMMARY

In order to address the limitations of existing tree species classification methods, which predominantly focus on single-label classification tasks while neglecting hierarchical multi-label classification, and fail to achieve high-precision species classification through label hierarchy, this disclosure proposes a deep learning automatic classification tree species method based on remote sensing images. By leveraging the hierarchical relationships among labels, this method constructs a hierarchical tree species data set and designs a corresponding hierarchical classification model. It thereby enables higher-level classification accuracy to assist in improving the classification performance for more fine-grained, lower-level tree species.

A deep learning automatic classification tree species method based on remote sensing images, the method is implemented by the following steps:
Step 1: Constructing a hierarchical tree species classification data set at different scales;
classifying both stand-scale and canopy-scale tree species remote sensing image single-label data sets by a hierarchical classification system to construct a hierarchical stand-scale tree species data set and a hierarchical canopy-scale tree species data set at different scales; labels of the hierarchical stand-scale tree species data set and the hierarchical canopy-scale tree species data set include a land cover label Level 0, a foliage type label Level 1, and a tree species identification label Level 2.
Step 2: Constructing a hierarchical tree species classification model;
constructing a hierarchical classifier through a backbone network to construct the hierarchical tree species classification model; the hierarchical classifier includes a Level 1 foliage type classifier and a Level 2 tree species classifier;
the Level 2 tree species classifier includes a broadleaf classifier, a needleleaf classifier, and a switcher;
processing an input image by the Level 1 foliage type classifier, and outputting a foliage type label corresponding to Level 1;
inputting the foliage type label in the Level 2 tree species classifier, and then inputting an image to the broadleaf classifier or needleleaf classifier by the Level 2 tree species classifier according to the foliage type;
determining an input image processed by one of the classifiers via the switcher according to output results of the broadleaf classifier and the needleleaf classifier.
Step 3: Evaluating a transferability of the hierarchical tree species classification model described in Step 2;
using two fine-tuning strategies and a scratch-based training model to train on the training set and verify them on the validation set of different proportions of hierarchical canopy-scale tree species data sets, comparing a prediction accuracy and a running time of different strategies on a test set to evaluate a transferability of a Switcher Hierarchical Net (Switcher-HNet).

The beneficial effects of the invention are as follows:

In the method of this invention, the hierarchical tree species classification model can utilize the relationships between labels to classify tree species, which effectively reduces the error propagation associated with the local classifier framework. This method surpasses the baseline model at two classification levels, highlighting the advantages of hierarchical classification in multi-label tree species classification.

In the method of this invention, the hierarchical tree species classification model is employed to reduce misclassification between needleleaf and broadleaf trees. This improvement results from the dynamic adjustment of predictions by the switcher and the collaborative operation of the classifiers, which together work to reduce the overall classification error.

In the method of the invention, any single-label tree species classification data set can be converted into a hierarchical multi-label data set.

In the method of the invention, the hierarchical tree species classification model can utilize the label hierarchical structure information in the constructed hierarchical multi-label data set to improve the accuracy of tree species classification.

In the method of the invention, the hierarchical tree species classification model demonstrates good performance on both canopy-scale and stand-scale data sets, reflecting the generalization ability of the method.

### BRIEF DESCRIPTION OF THE DRAWINGS

FIG. 1 is a flow chart of a deep learning automatic tree species classification method based on remote sensing images described in the invention;

FIG. 2 is a structural diagram of the hierarchical tree species classification model.

FIG. 3 is a working principle diagram of the switcher in the hierarchical tree species classification model.

FIG. 4 is a prediction result diagram of the hierarchical tree species classification model.

FIG. 5 is a comparison result diagram of strategy performance with different data proportions.

FIG. 6 is a model running time result of different strategies.

### DETAILED DESCRIPTION OF THE EMBODIMENTS

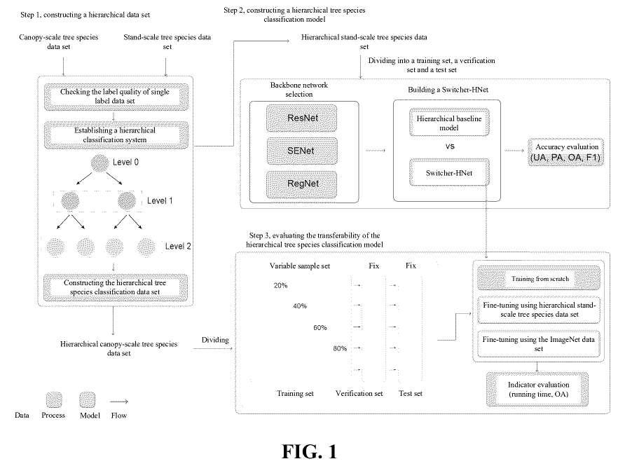

Combined with FIG. 1-FIG. 6, this embodiment is based on the deep learning automatic classification of tree species based on remote sensing images. The method is implemented by the following steps:
Step 1: Constructing a hierarchical tree species classification data set;

The single-label data sets of tree species remote sensing images at stand and canopy scales are obtained, and a hierarchical classification system is established. This hierarchical classification system implements a three-level progressive classification. Level 0 label (land cover): Land cover label Level 0 classifies land cover types, and binary classification [forest/non-forest] is used as the basic layer of classification. Level 1 label (foliage type): foliage type label Level 1 distinguishes trees in the forest according to leaf characteristics, classifies needleleaf or broadleaf trees in the forest area, and establishes morphological features; Level 2 label (Tree species identification): Tree species identification label Level 2 is used to identify tree species in the categories defined in foliage type label Level 1 and provides classification by specifying individual tree species names; based on Level 1 classification, the end nodes are classified according to spectral-texture features, including specific tree species such as Korean pine and spruce. Two hierarchical tree species classification data sets of different scales are constructed by the hierarchical classification system, which are the hierarchical stand-scale tree species data set and the hierarchical canopy-scale tree species data set.

Step 2: Constructing a hierarchical tree species classification model (Switcher-HNet), and using hierarchical information to improve model accuracy.

A hierarchical classifier is built through the backbone network to construct a hierarchical tree species classification model; the hierarchical classifier includes the Level 1 foliage type classifier and the Level 2 tree species classifier.

The Level 2 tree species classifier includes a broadleaf classifier, a needleleaf classifier, and a switcher.

The input image is processed by the Level 1 foliage type classifier, and the foliage type corresponding to Level 1 is output.

The foliage type is input to the Level 2 tree species classifier, and then input to the broadleaf classifier or needleleaf classifier via the Level 2 tree species classifier according to the foliage type.

The switcher determines the input image processed by one of the classifiers according to the output results of the broadleaf classifier and the needleleaf classifier.

As shown in FIG. 1, in this embodiment, the hierarchical tree species classification model first selects the appropriate neural network architecture (any model in ResNet, SENet or RegNet models can be selected) as the backbone network, and then evaluates the performance of the hierarchical tree species classification model, and compares it with the flat classification baseline model for accuracy evaluation (UA, PA, OA, F1).

In this embodiment, the hierarchical forest stand scale tree species data set is divided into training set, validation set and test set; in the training phase, each classifier in the hierarchical classifier is trained independently on the training set of the hierarchical stand-scale tree species data set, and its performance is evaluated on the validation set to focus on distinguishing their respective levels in the hierarchy. In the inference stage, these classifiers are combined with the switcher mechanism to generate comprehensive predictions and output the final classification results on the test set. Specifically, after predicting Level 2, these results are used to refine and update the prediction of Level 1. The iterative process is based on hierarchical relationships, where Level 2 naturally belongs to a broader category defined by Level 1. By aligning the Level 2 prediction with its corresponding Level 1 category, the hierarchical structure of the tree species is ensured, thereby improving the accuracy of the final classification results.

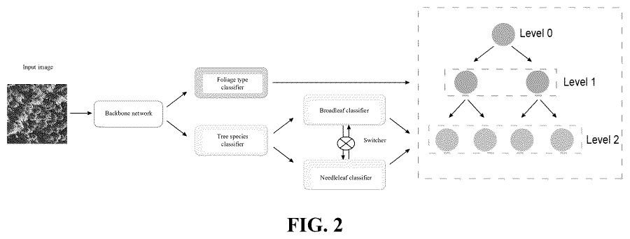

As shown in FIG. 2, the hierarchical tree species classification model is composed of a hierarchical classifier built by a backbone network, which aims to improve the classification accuracy of tree species by using the hierarchical labels of tree species. The hierarchical classifier has two levels of classification: Level 1 foliage type classifier and Level 2 tree species classifier. The Level 1 foliage type classifier consists of a convolutional layer and a fully connected layer. The final fully connected layer has two classification nodes, and the input area is divided into two main categories: ‘broadleaf’ and ‘needleleaf’. This initial classification determines the subsequent processing path of each input. The Level 2 tree species classifier includes a broadleaf classifier, a needleleaf classifier, and a switcher. The broadleaf classifier and the needleleaf classifier are both composed of a convolutional layer and a fully connected layer. The final fully connected layer serves as the output layer and has multiple classification nodes. The broadleaf classifier is specifically used to identify various broadleaf species, while the needleleaf classifier focuses on different needleleaf species. The broadleaf and needleleaf classifiers use the softmax activation function in their output layer, that is, the original score is converted to a probability interval of 0-1, and the most likely tree species are selected. Then, the switcher determines which classifier should process the input image according to the performance of the two classifiers.

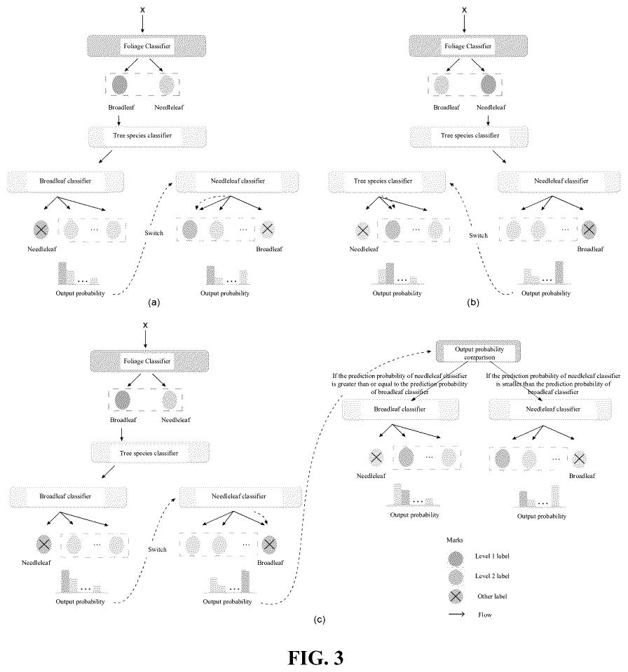

In this embodiment, the switcher includes three redirection options, as shown in FIG. 3. In the figure, (a) is a one-way redirection from broadleaf to needleleaf: initially, the input image is processed by a foliage type classifier, followed by a tree species classifier. If the foliage type classifier predicts that the input image belongs to the ‘broadleaf’ category, it will be guided to the broadleaf classifier. In addition to evaluating various broadleaf species labels, the classifier also adds a ‘Needleleaf’ classification label, which contains all needleleaf species. When the broadleaf classifier predicts that the maximum possible probability of the input image is ‘Needleleaf’, the switcher turns it to the needleleaf classifier. The needleleaf classifier then assigns a specific needleleaf species label to the input image. In the figure, (b) is a one-way redirection from needleleaf to broadleaf: Initially, the input image is processed by a foliage type classifier, followed by a tree species classifier. If the foliage type classifier predicts that the input image belongs to the ‘needleleaf’ category, it will be guided to the needleleaf classifier. In addition to evaluating various needleleaf species labels, the classifier also adds a ‘Broadleaf’ classification label, which contains all broadleaf species. When the needleleaf classifier predicts that the maximum probability of the input image is ‘Broadleaf’, the switcher turns it to the broadleaf classifier. The broadleaf classifier then assigns specific hardwood species labels to the input image. In the figure, (c) is the two-way redirection of broadleaf and needleleaf: Initially, the input image is processed by the foliage type classifier, followed by the tree species classifier. If the broadleaf classifier predicts that the image is a ‘needleleaf’, and the needleleaf classifier predicts that it is a ‘broadleaf’, the switcher selects the appropriate classifier according to the highest prediction probability of the two classifiers, and outputs the specific tree species label in Level 2. After selecting a redirection option, the model outputs a vector containing two labels: One from Level 1 (foliage type) and one from Level 2 (tree species).

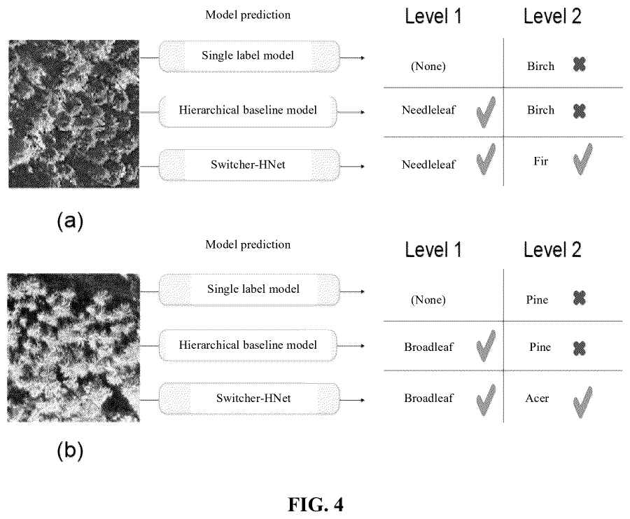

As shown in FIG. 4, according to the model prediction results in FIG. 4, the hierarchical tree species classification model can use Level 1 to identify Level 2 more accurately than the single-label model and the hierarchical baseline model. As shown in (a) of this figure, when the single-label model is predicted to be ‘birch’ (belonging to broadleaf), the hierarchical baseline model can correctly predict ‘needleleaf’ at Level 1, and the hierarchical tree species classification model can use ‘needleleaf’ to correctly predict that the needleleaf species at Level 2 is ‘fir’. As shown in (b), when the single-label model is predicted to be ‘pine’ (belonging to needleleaf), the hierarchical baseline model can correctly predict ‘broadleaf’ at Level 1, and the hierarchical tree species classification model can use ‘broadleaf’ to correctly predict that the broadleaf species at Level 2 is ‘maple’.

Step 3: Evaluating the transferability of the hierarchical tree species classification models, two fine-tuning strategies and training from scratch are used on different proportions of training sets, including comparisons of the prediction accuracy and running time across different strategies.

In this embodiment, the hierarchical canopy-scale tree species data set is divided into a training set, a validation set, and a test set; the proportion is 6:2:2. After building a hierarchical tree species classification model, the hierarchical canopy-scale tree species data set obtained in Step 1 is used to evaluate the transferability of the hierarchical tree species classification model. For the training set, each tree species used a random sampling method to create training data subsets with different proportions (20%, 40%, 60%, 80%, and 100%), while the validation set and the test set remain unchanged.

Three strategies are compared and analyzed: Using the canopy scale data set to train the hierarchical tree species classification model from scratch, using the hierarchical tree species classification model pre-trained by the hierarchical stand-scale tree species data set in FIG. 1 to fine-tune, and using the hierarchical tree species classification model pre-trained on the ImageNet data set (which is a general data set in the field of computer vision and has good generalization) to fine-tune.

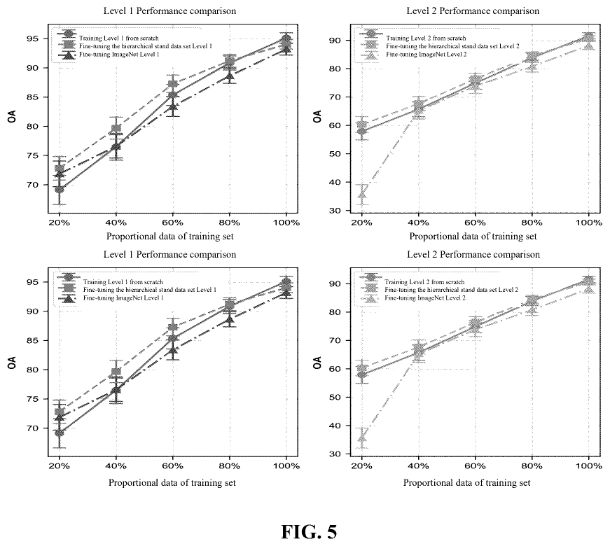

In this embodiment, as shown in FIG. 5, with the increase of the proportion of the training set, the accuracy of the three strategies is improved. The training accuracy of the fine-tuning strategy using 20%, 40%, 60%, and 80% data proportions is higher than that of the scratch-trained model. However, when using a 100% data proportion, the model trained from scratch has the highest accuracy.

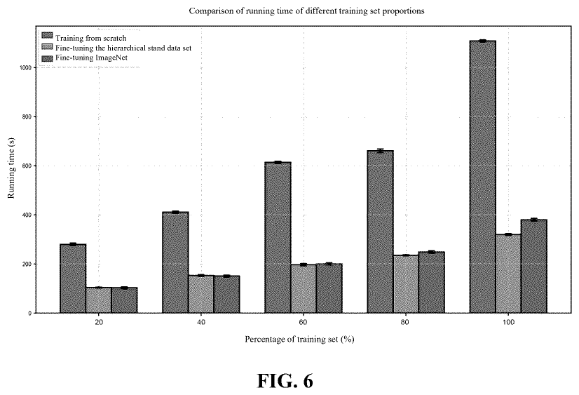

As shown in FIG. 6, for all strategies, it takes a long time to train the model from scratch. In contrast, the training time required for both the hierarchical stand-scale tree species data set and the fine-tuning of the ImageNet data set is significantly reduced.

The transferability of the hierarchical tree species classification model described in this embodiment shows that the fine-tuning strategy can effectively transfer between different data sets, especially on data sets in similar fields (such as stand-scale and canopy-scale tree species data sets). Compared with the general data set ImageNet, the fine-tuning strategy not only improves the accuracy, but also maintains a lower computing resource requirement.

The technical features of the above embodiment can be arbitrarily combined. In order to make the description simple, all possible combinations of the technical features in the above implementations are not described. However, as long as there is no contradiction in the combination of these technical features, it should be considered as the scope recorded in this specification.

The above embodiment only expresses several embodiments of the invention, and their descriptions are more specific and detailed, but they cannot be understood as restrictions on the scope of the invention. It should be pointed out that for the ordinary technical personnel in this field, some deformations and improvements can be made without breaking away from the idea of the invention, which are all within the scope of protection of the invention. Therefore, the scope of protection of the invention patent should be subject to the attached claims.

What is claimed is:

1. A deep learning automatic classification tree species method based on remote sensing images, the method is implemented by the following steps:
Step 1: constructing a hierarchical tree species classification data set at different scales, by:
classifying both stand-scale and canopy-scale tree species remote sensing image single-label data sets by a hierarchical classification system to construct a hierarchical stand-scale tree species data set and a hierarchical canopy-scale tree species data set at different scales, wherein labels of the hierarchical stand-scale tree species data set and the hierarchical canopy-scale tree species data set comprise a land cover label Level 0, a foliage type Level 1, and a tree species identification label Level 2;
Step 2: constructing a hierarchical tree species classification model, by:
constructing a hierarchical classifier through a backbone network to construct the hierarchical tree species classification model, wherein the hierarchical classifier comprises a Level 1 foliage type classifier and a Level 2 tree species classifier;
wherein the Level 2 tree species classifier comprises a broadleaf classifier, a needleleaf classifier, and a switcher;
processing an input image with the Level 1 foliage type classifier, and outputting a foliage type label corresponding to Level 1;
inputting the foliage type label in the Level 2 tree species classifier, and then inputting an image to the broadleaf classifier or needleleaf classifier usig the Level 2 tree species classifier according to the foliage type;
wherein classification of an input image processed by one of the classifiers via the switcher is determined according to output results of the broadleaf classifier and the needleleaf classifier;
Step 3: evaluating a transferability of the hierarchical tree species classification model described in Step 2, by:
using two fine-tuning strategies and a scratch-based training model to train on the training set and verify them on the validation set of different proportions of hierarchical canopy-scale tree species data sets, and comparing a prediction accuracy and a running time of different strategies on a test set to evaluate a transferability of a Switcher Hierarchical Net(Switcher-HNet).

2. The deep learning automatic classification tree species method based on remote sensing images according to claim 1, wherein the hierarchical classification system implements a three-level progressive classification, wherein: land cover label Level 0 classifies land cover types as a basic layer of classification; foliage type label Level 1 distinguishes trees in a forest according to leaf characteristics and classifies into needleleaf or broadleaf, and establishes morphological features; and tree species identification label Level 2 is used to identify tree species in categories defined in foliage type label Level 1 and provides a classification by specifying individual tree species names.

3. The deep learning automatic classification tree species method based on remote sensing images according to claim 1, wherein in Step 2, the method also comprises training the hierarchical tree species classification model, wherein the hierarchical forest stand scale tree species data set in Step 1 is divided into a training set, a validation set and a test set; each classifier in the hierarchical classifier is trained independently on the training set of the hierarchical stand-scale tree species data set, and its performance is evaluated on the validation set to clearly distinguish the labels of each classifier at the corresponding level in the corresponding hierarchy; and, in a prediction output stage, the broadleaf classifier, the needleleaf classifier and the switcher are combined to generate a full prediction and output a final classification result on the test set.

4. The deep learning automatic classification tree species method based on remote sensing images according to claim 1, wherein the switcher comprises three redirection options, namely: a one-way redirection from broadleaf to needleleaf; a one-way redirection from needleleaf to broadleaf; and a two-way redirection from broadleaf to needleleaf.

5. The deep learning automatic classification tree species method based on remote sensing images according to claim 4, wherein a specific process of one-way redirection from broadleaf to needleleaf comprises:
when the foliage type classifier of Level 1 predicts that an input image belongs to a broadleaf category, the input image is recognized by the broadleaf classifier; and, when the broadleaf classifier predicts that a maximum probability of the input image is a needleleaf category, the input image is turned to the needleleaf classifier by the switcher for recognition and the needleleaf classifier assigns needleleaf species labels to the input image; and,
the broadleaf classifier also adds a needleleaf classification label, wherein the classification label comprises all needleleaf tree species.

6. The deep learning automatic classification tree species method based on remote sensing images according to claim 4, wherein the specific process of the one-way redirection from needleleaf to broadleaf comprises:
when the foliage type classifier of Level 1 predicts that the input image belongs to the needleleaf category, the input image is identified by the needleleaf classifier; when the needleleaf classifier predicts that the maximum probability of the input image is the broadleaf category, the input image is turned to the broadleaf classifier by the switcher, and the broadleaf classifier assigns broadleaf species labels to the input image; and,
the needleleaf classifier also adds a broadleaf classification label, wherein the classification label comprises all broadleaf tree species.

7. The deep learning automatic classification tree species method based on remote sensing images according to claim 4, wherein the specific process of the two-way redirection of broadleaf and needleleaf comprises:
if the broadleaf classifier predicts that the input image is the needleleaf category, and the needleleaf classifier predicts that the input image is the broadleaf category, the appropriate classifier is selected by the switcher according to a highest prediction probability between the two classifiers, and the corresponding Level 2 tree species label is output.

8. The deep learning automatic classification tree species method based on remote sensing images according to claim 1, wherein the Level 1 foliage type classifier is composed of a convolution layer and a fully connected layer, and a fully connected layer is set with two classification nodes to distinguish the corresponding foliage type categories.

9. The deep learning automatic classification tree species method based on remote sensing images according to claim 1, wherein the broadleaf classifier and the needleleaf classifier are composed of convolution layers and fully connected layers, the last fully connected layer is used as the output layer with multiple classification nodes, the broadleaf classifier is used to identify various broadleaf species, and the needleleaf classifier is used to identify different needleleaf species; wherein the broadleaf classifier and the needleleaf classifier use a softmax activation function in the output layer wherein an original score is converted into a probability interval of 0-1, and the tree species with a highest probability are selected.

10. The deep learning automatic classification tree species method based on remote sensing images according to claim 1, wherein in Step 3, the two fine-tuning strategies are as follows: fine-tuning the hierarchical tree species classification model trained on the hierarchical stand-scale tree species data set, and fine-tuning the hierarchical tree species classification model trained on an ImageNet data set.
